(19) United States
(12) Patent Application Publication
(10) Pub. No.: US 2020/0066432 A1
(43) Pub. Date: Feb. 27, 2020

(54) MULTILAYER COIL COMPONENT

(71) Applicant: TDK CORPORATION, Tokho (JP)

(72) Inventors: Yuma ISHIKAWA, Tokyo (JP); Makoto YOSHINO, Tokyo (JP)

(73) Assignee: TDK CORPORATION, Tokyo (JP)

(21) Appl. No.: 16/540,778

(22) Filed: Aug. 14, 2019

(30) Foreign Application Priority Data
Aug. 27, 2018 (JP) 2018-158586

(51) Int. Cl. H01F 17/00; H01F 27/29; H01F 17/06; H01F 27/28

(52) U.S. Cl. CPC H01F 17/0013; H01F 27/292; H01F 2017/065; H01F 27/2804; H01F 2017/0093; H01F 17/06

(57) ABSTRACT

A multilayer coil component includes an element body and a coil conductor. The element body has a non-magnetic portion and a pair of magnetic portions. One of the pair of magnetic portions includes a first magnetic region, a first non-magnetic region, a second magnetic region, and a second non-magnetic region. A sum of a first length of the non-magnetic portion in a lamination direction and a second length of the first non-magnetic region in the lamination direction is equal to or less than a third length of the first magnetic region in the lamination direction. A sum of the second length and a fourth length of the second non-magnetic region in the lamination direction is equal to or less than a fifth length of the second magnetic region in the lamination direction. The fourth length is equal to or greater than the second length.

### TECHNICAL FIELD

The present disclosure relates to a multilayer coil component.

### BACKGROUND

Japanese Unexamined Patent Publication No. 2006-319009 discloses a common mode noise filter including a non-magnetic layer, magnetic layers sandwiching the non-magnetic layer, a planar coil disposed in the non-magnetic layer, and external end surface electrodes connected to the planar coil. The magnetic layer has a multilayer structure in which an oxide magnetic layer is laminated via an insulator layer containing a glass component. The glass component of the insulator layer diffuses in the vicinity of the interface with the insulator layer in the oxide magnetic layer. As a result, firing of an oxide magnetic layer becomes less likely near the interface, and thus thermal contraction is suppressed.

### SUMMARY

In the common mode noise filter described above, structural defects such as peeling and cracks may occur in the magnetic layer having the multilayer structure. In addition, deterioration of the magnetic properties of the magnetic layer may occur.

The present disclosure provides a multilayer coil component with which structural defects and deterioration of magnetic properties as well as thermal contraction can be suppressed.

The present inventors have newly found the following facts as a result of research.

In the common mode filter described above, the insulator layer is provided only on one side in the oxide magnetic layer constituting the outermost layer of the multilayer structure. Accordingly, the stresses on both sides of the oxide magnetic layer may not be balanced and structural defects such as peeling and cracks may occur. Although a predetermined thickness is required for the insulator layer to be formed, an excessively thick insulator layer may lead to an increase in the amount the glass component of the insulator layer diffuses and deterioration of the magnetic properties of the oxide magnetic layer.

In this regard, a multilayer coil component according to one aspect of the present disclosure includes an element body and a coil conductor. The element body has a non-magnetic portion and a pair of magnetic portions disposed in such a way as to sandwich the non-magnetic portion. The coil conductor is disposed in the non-magnetic portion. At least one of the pair of magnetic portions includes a first magnetic region, a first non-magnetic region, a second magnetic region, and a second non-magnetic region that are laminated in this order on the non-magnetic portion. Each of the non-magnetic portion, the first non-magnetic region, and the second non-magnetic region contains a glass component. A sum of a first length of the non-magnetic portion in a lamination direction and a second length of the first non-magnetic region in the lamination direction is equal to or less than a third length of the first magnetic region in the lamination direction. A sum of the second length and a fourth length of the second non-magnetic region in the lamination direction is equal to or less than a fifth length of the second magnetic region in the lamination direction. The fourth length is equal to or greater than the second length.

In the aspect described above, at least one of the pair of magnetic portions includes the first magnetic region, the first non-magnetic region, the second magnetic region, and the second non-magnetic region that are laminated in this order on the non-magnetic portion. The first magnetic region and the second magnetic region are provided via the first non-magnetic region, and thus the thermal contraction of the first magnetic region and the second magnetic region is suppressed.

The non-magnetic portion and the first non-magnetic region are disposed on both sides of the first magnetic region. As a result, the stresses on both sides of the first magnetic region are balanced. Accordingly, the structural defects such as the peeling and cracks attributable to the imbalance between the stresses on both sides are suppressed. The first non-magnetic region and the second non-magnetic region are disposed on both sides of the second magnetic region. As a result, the stresses on both sides of the second magnetic region are balanced. Accordingly, the structural defects such as the peeling and cracks attributable to the imbalance between the stresses on both sides are suppressed.

The sum of the first length and the second length is equal to or less than the third length. As a result, an increase in the amount the glass components of the non-magnetic portion and the first non-magnetic region diffuse to the first magnetic region is suppressed. Accordingly, deterioration of the magnetic properties of the first magnetic region is suppressed. The sum of the second length and the fourth length is equal to or less than the fifth length. As a result, an increase in the amount the glass components of the first non-magnetic region and the second non-magnetic region diffuse to the second magnetic region is suppressed. Accordingly, deterioration of the magnetic properties of the second magnetic region is suppressed.

The fourth length is equal to or greater than the second length. Accordingly, the volume of the second non-magnetic region is equal to or greater than the volume of the first non-magnetic region, and thus a configuration in which the strength of the second non-magnetic region is equal to or greater than the strength of the first non-magnetic region can be realized with ease. The second non-magnetic region is disposed closer to the outer side of the element body than the first non-magnetic region and is susceptible to external stress. Accordingly, the structural defects can be further suppressed by the configuration in which the strength of the second non-magnetic region is equal to or greater than the strength of the first non-magnetic region.

In the aspect described above, each of the pair of magnetic portions may include the first magnetic region, the first non-magnetic region, the second magnetic region, and the second non-magnetic region that are laminated in this order on the non-magnetic portion. In this case, it is possible to suppress structural defects and deterioration of magnetic properties as well as thermal contraction in each of the pair of magnetic portions.

The multilayer coil component may further include an external electrode disposed on the element body and connected to the coil conductor. The external electrode may have a conductive resin layer. In this case, the external force that acts on the multilayer coil component from an electronic device can be suppressed when, for example, the multilayer coil component is solder-mounted onto the electronic device. Accordingly, the structural defects can be further suppressed.

The multilayer coil component may further include an external electrode and an amorphous glass coat layer. The external electrode may be disposed on the element body and connected to the coil conductor. The amorphous glass coat layer may be disposed between the element body and the external electrode and be in contact with the element body and the external electrode. In this case, the adhesion between the element body and the external electrode can be enhanced. Accordingly, peeling of the external electrode is suppressed.

### BRIEF DESCRIPTION OF THE DRAWINGS

FIG. 1 is a perspective view illustrating a multilayer common mode filter according to an embodiment.

FIG. 2 is a cross-sectional view illustrating the multilayer common mode filter in FIG. 1.

FIG. 3 is a cross-sectional view illustrating the multilayer common mode filter in FIG. 1.

FIG. 4 is an exploded perspective view illustrating the configuration of a non-magnetic portion.

FIG. 5 is a cross-sectional view illustrating a multilayer common mode filter according to a modification example of the present embodiment.

FIG. 6 is a cross-sectional view illustrating the multilayer common mode filter according to the modification example of the present embodiment.

### DETAILED DESCRIPTION

Hereinafter, an embodiment will be described in detail with reference to accompanying drawings. In the description, the same elements or elements having the same functions will be denoted by the same reference numerals without redundant description.

The configuration of a multilayer common mode filter CF according to the present embodiment will be described with reference to

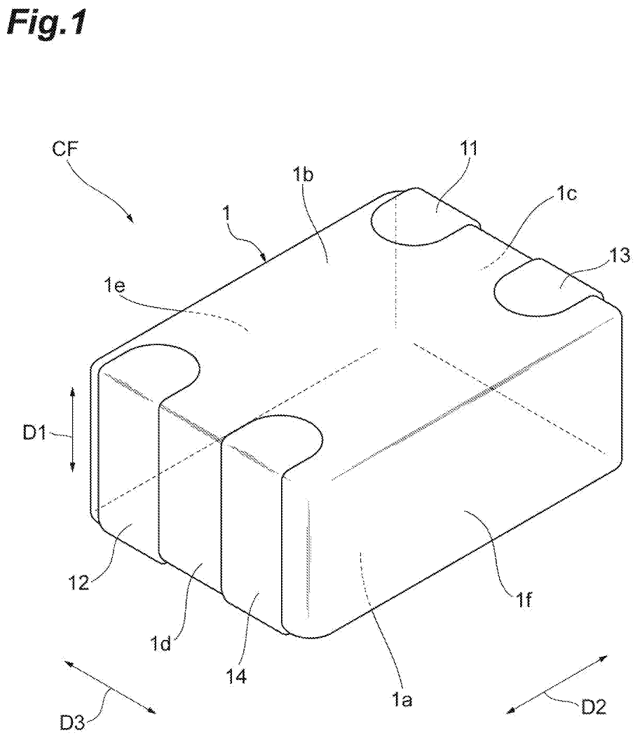

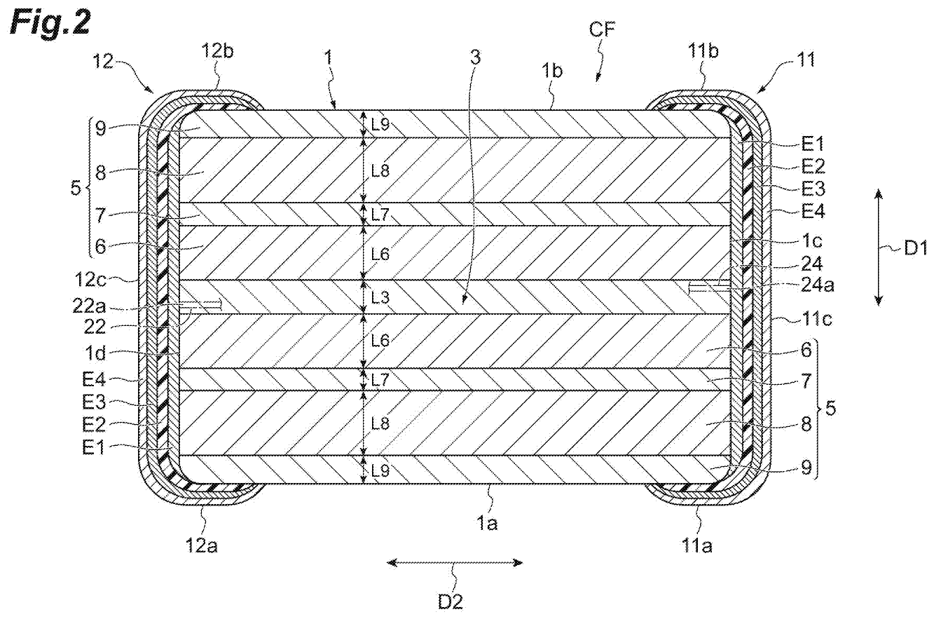

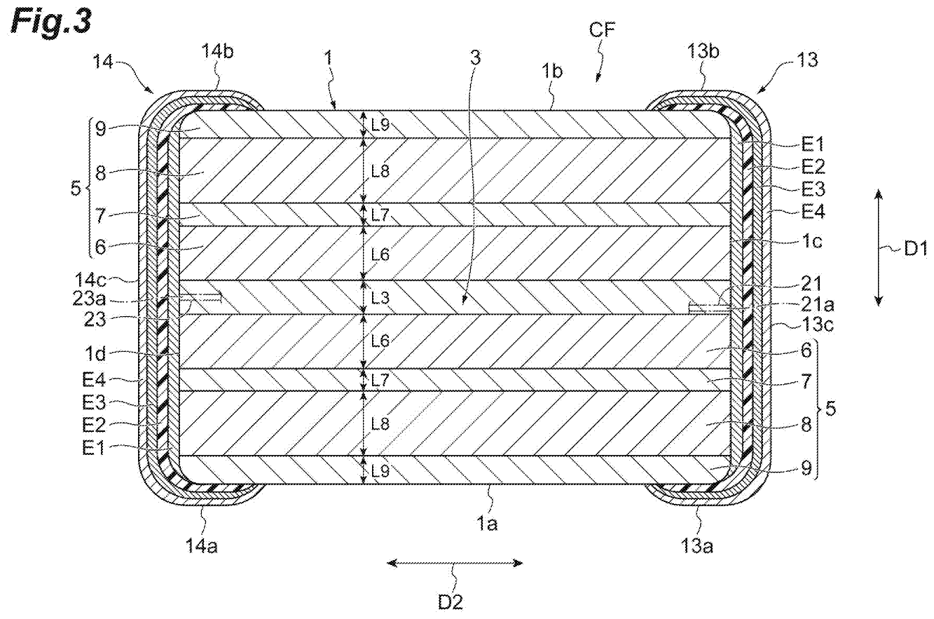

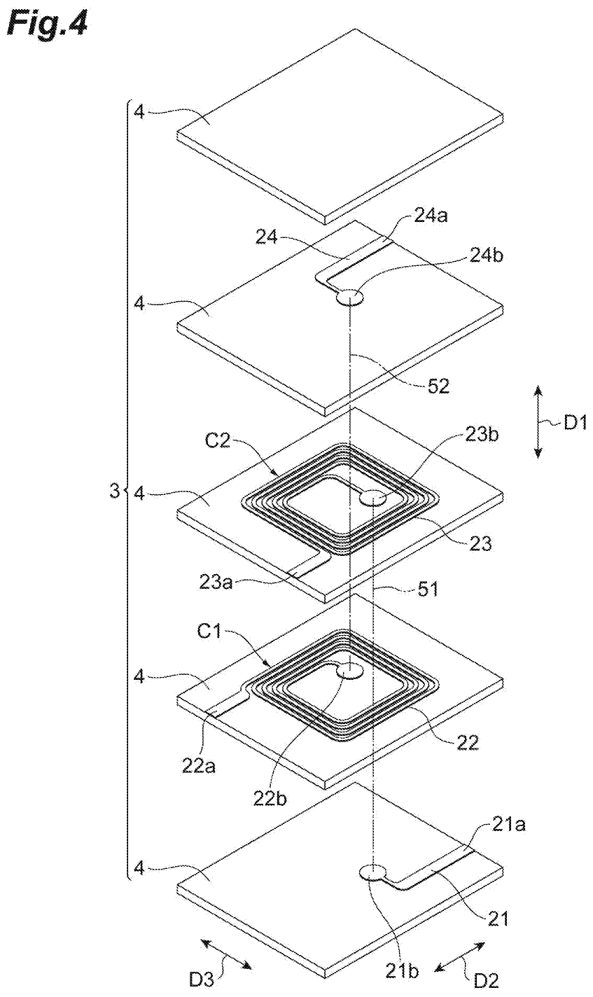

FIGS. 1 to 4. FIG. 1 is a perspective view illustrating the multilayer common mode filter according to the present embodiment. FIGS. 2 and 3 are cross-sectional views illustrating the multilayer common mode filter in FIG. 1. FIG. 4 is an exploded perspective view illustrating the configuration of a non-magnetic portion. In the present embodiment, the multilayer common mode filter CF will be described as an example of a multilayer coil component.

The multilayer common mode filter CF is provided with an element body 1 and a plurality of external electrodes disposed on the element body 1 as illustrated in FIGS. 1 to 4. A terminal electrode 11, a terminal electrode 12, a terminal electrode 13, and a terminal electrode 14 constitute the plurality of external electrodes. The multilayer common mode filter CF is solder-mounted onto an electronic device (such as a circuit board and an electronic component) in such a way that the terminal electrodes 11 to 14 are respectively connected to signal lines.

The element body 1 has a rectangular parallelepiped shape. The element body 1 has a main surface 1a and a main surface 1b opposing each other, a side surface 1c and a side surface 1d opposing each other, and a side surface 1e and a side surface 1f opposing each other as the outer surfaces of the element body 1. When the multilayer common mode filter CF is solder-mounted onto the electronic device, the main surface 1a or the like is a mounting surface opposing the electronic device.

The direction in which the main surface 1a and the main surface 1b oppose each other is a first direction D1, the direction in which the side surface 1c and the side surface 1d oppose each other is a second direction D2, and the direction in which the side surface 1e and the side surface if oppose each other is a third direction D3. In the present embodiment, the first direction D1 is the height direction of the element body 1, the second direction D2 is the longitudinal direction of the element body 1, and the third direction D3 is the width direction of the element body 1. The rectangular parallelepiped shape includes the shape of a rectangular parallelepiped having chamfered corners and ridges and the shape of a rectangular parallelepiped having rounded corners and ridges.

The side surface 1c and the side surface 1d extend in the first direction D1 in such a way as to connect the main surface 1a and the main surface 1b. The side surface 1c and the side surface 1d are adjacent to the main surface 1b as well as the main surface 1a. The side surface 1c and the side surface 1d extend in the third direction D3 (short side direction of the main surface 1a and the main surface 1b) as well.

The side surface 1e and the side surface 1f extend in the first direction D1 in such a way as to connect the main surface 1a and the main surface 1b. The side surface 1c and the side surface 1d are adjacent to the main surface 1b as well as the main surface 1a. The side surface 1e and the side surface 1f extend in the second direction D2 (long side direction of the main surface 1a and the main surface 1b) as well.

The element body 1 has a non-magnetic portion 3 and a pair of magnetic portions 5 disposed in such a way as to sandwich the non-magnetic portion 3 in the first direction D1. The non-magnetic portion 3 includes a plurality of laminated non-magnetic layers 4. In other words, the non-magnetic portion 3 has a multilayer structure in which the plurality of non-magnetic layers 4 are laminated. Here, the non-magnetic portion 3 has a five-layer structure.

Each of the magnetic portions 5 has a magnetic region 6, a non-magnetic region 7, a magnetic region 8, and a non-magnetic region 9. In each of the magnetic portions 5, the magnetic region 6, the non-magnetic region 7, the magnetic region 8, and the non-magnetic region 9 are laminated in this order on the non-magnetic portion 3. In other words, the magnetic region 6 is provided on the non-magnetic portion 3, the non-magnetic region 7 is provided on the magnetic region 6, the magnetic region 8 is provided on the non-magnetic region 7, and the non-magnetic region 9 is provided on the magnetic region 8. The magnetic region 6 is disposed on the innermost side of the magnetic portion 5. The non-magnetic region 9 is disposed on the outermost side of the magnetic portion 5 and the outermost side of the element body 1.

The sum of a lamination-direction length L3 of the non-magnetic portion 3 and a lamination-direction length L7 of the non-magnetic region 7 is equal to or less than a lamination-direction length L6 of the magnetic region 6 (L3+L7≤L6). The sum of the length L7 and a lamination-direction length L9 of the non-magnetic region 9 is equal to or less than a lamination-direction length L8 of the magnetic region 8 (L7+L9≤L8). The length L7 is equal to or less than the length L9. The lengths L3, L7, and L9 are 0.1 μm or more.

The magnetic regions 6 and 8 include a plurality of laminated magnetic layers. In other words, the magnetic regions 6 and 8 have a multilayer structure in which the plurality of magnetic layers are laminated. The magnetic region 6 includes a magnetic layer constituting the innermost layer of the magnetic portion 5. The non-magnetic regions 7 and 9 include a plurality of laminated non-magnetic layers. In other words, the non-magnetic regions 7 and 9 have a multilayer structure in which the plurality of non-magnetic layers are laminated. The non-magnetic region 9 includes a magnetic layer constituting the outermost layer of the magnetic portion 5 and constituting the outermost layer of the element body 1. The same material as the non-magnetic layer 4 or the like may constitute the non-magnetic layers included in the non-magnetic region 7 and the non-magnetic region 9.

Each of the non-magnetic layers 4 included in the non-magnetic portion 3 and each of the non-magnetic layers included in the non-magnetic region 7 and the non-magnetic region 9 contain a glass component and are formed of, for example, a sintered ceramic green sheet body containing a glass ceramic material as a non-magnetic material. In other words, each of the non-magnetic portion 3, the non-magnetic region 7, and the non-magnetic region 9 contains a glass component. Each of the magnetic layers included in the magnetic region 6 and the magnetic region 8 is formed of, for example, a sintered ceramic green sheet body containing a Ni—Cu—Zn-based ferrite material, a Ni—Cu—Zn—Mg-based ferrite material, a Ni—Cu-based ferrite material, or the like as a magnetic material.

In actuality, in the element body 1, each of the non-magnetic layers 4 included in the non-magnetic portion 3 is integrated to such an extent that the boundary between the layers cannot be visually recognized. Each of the non-magnetic layers included in the non-magnetic region 7 is integrated to such an extent that the boundary between the layers cannot be visually recognized. Each of the non-magnetic layers included in the non-magnetic region 9 is integrated to such an extent that the boundary between the layers cannot be visually recognized. Each of the magnetic layers included in the magnetic region 6 is integrated to such an extent that the boundary between the layers cannot be visually recognized. Each of the magnetic layers included in the magnetic region 8 is integrated to such an extent that the boundary between the layers cannot be visually recognized. The direction in which each of these layers is laminated (hereinafter, simply referred to as “lamination direction”) coincides with the first direction D1, that is, the direction in which the main surface 1a and the main surface 1b oppose each other.

The multilayer common mode filter CF is provided with a plurality of internal conductors disposed in the non-magnetic portion 3. A connection conductor 21, a coil conductor 22, a coil conductor 23, and a connection conductor 24 constitute the plurality of internal conductors. The connection conductor 21, the coil conductor 22, the coil conductor 23, and the connection conductor 24 contain a conductive material (such as Ag and Pd). The connection conductor 21, the coil conductor 22, the coil conductor 23, and the connection conductor 24 are configured as a sintered body of conductive paste containing a conductive material (such as Ag powder and Pd powder).

The connection conductor 21 is disposed between a pair of the non-magnetic layers 4 adjacent in the lamination direction. One end (outside end) 21a of the connection conductor 21 is exposed to the side surface 1c. The other end (inside end) 21b of the connection conductor 21 is formed in a pad shape.

The coil conductor 22 is disposed between a pair of the non-magnetic layers 4 adjacent in the lamination direction. The coil conductor 22 constitutes a spiral coil C1. One end (outside end) 22a of the coil conductor 22 is exposed to the side surface 1d. The other end (inside end) 22b of the coil conductor 22 is formed in a pad shape. The coil conductor 22 is adjacent to the connection conductor 21 via the non-magnetic layer 4 in the lamination direction.

The coil conductor 23 is disposed between a pair of the non-magnetic layers 4 adjacent in the lamination direction. The coil conductor 23 constitutes a spiral coil C2. One end (outside end) 23a of the coil conductor 23 is exposed to the side surface 1d. The other end (inside end) 23b of the coil conductor 23 is formed in a pad shape. The coil conductor 23 is adjacent to the coil conductor 22 via the non-magnetic layer 4 in the lamination direction.

The connection conductor 24 is disposed between a pair of the non-magnetic layers 4 adjacent in the lamination direction. One end (outside end) 24a of the connection conductor 24 is exposed to the side surface 1c. The other end (inside end) 24b of the connection conductor 24 is formed in a pad shape. The connection conductor 24 is adjacent to the connection conductor 21 via the non-magnetic layer 4 in the lamination direction.

The connection conductor 21, the coil conductor 22, the coil conductor 23, and the connection conductor 24 are disposed in this order from the non-magnetic portion 3 side in the lamination direction. The coil conductor 22 and the coil conductor 23 are wound in the same direction and positioned in such a way as to be overlap each other when viewed from the lamination direction.

The other end 21b of the connection conductor 21 and the other end 23b of the coil conductor 23 are positioned in such a way as to overlap each other when viewed from the lamination direction. The other end 21b and the other end 23b are connected through a through hole conductor 51. The through hole conductor 51 penetrates the non-magnetic layer 4 positioned between the other end 21b and the other end 23b. The connection conductor 21 and the coil conductor 23 are electrically connected through the through hole conductor 51.

The other end 22b of the coil conductor 22 and the other end 24b of the connection conductor 24 are positioned in such a way as to overlap each other when viewed from the lamination direction. The other end 22b and the other end 24b are connected through a through hole conductor 52. The through hole conductor 52 penetrates the non-magnetic layer 4 positioned between the other end 22b and the other end 24b. The coil conductor 22 and the connection conductor 24 are electrically connected through the through hole conductor 52.

The multilayer common mode filter CF is provided with the coil C1 and the coil C2 in the element body 1 (non-magnetic portion 3). The coil conductor 22 constitutes the coil C1 and the coil conductor 23 constitutes the coil C2. The coil C1 and the coil C2 are disposed in the non-magnetic portion 3 in such a way as to be adjacent to each other in the lamination direction. The coil C1 and the coil C2 are magnetically coupled to each other.

The through hole conductor 51 and the through hole conductor 52 contain a conductive material (such as Ag and Pd). The through hole conductor 51 and the through hole conductor 52 are configured as a sintered body of conductive paste containing a conductive material (such as Ag powder and Pd powder). The through hole conductor 51 and the through hole conductor 52 are formed by sintering of the conductive paste with which penetration holes formed in the ceramic green sheets that are to constitute the corresponding non-magnetic layers 4 are filled.

The terminal electrode 11 and the terminal electrode 13 are disposed on the side surface 1c side of the element body 1. In other words, the terminal electrode 11 and the terminal electrode 13 are disposed in one end portion of the element body 1 in the second direction D2. The terminal electrode 11 and the terminal electrode 13 are disposed on the side surface 1c in such a way as to cover a part of the side surface 1c along the first direction D1 and are disposed on a part of the main surface 1a and on a part of the main surface 1b. The terminal electrode 11 is positioned close to the side surface 1e and the terminal electrode 13 is positioned close to the side surface 1f.

The terminal electrode 12 and the terminal electrode 14 are disposed on the side surface 1d side of the element body 1. In other words, the terminal electrode 12 and the terminal electrode 14 are disposed in the other end portion of the element body 1 in the second direction D2. The terminal electrode 12 and the terminal electrode 14 are disposed on the side surface 1d in such a way as to cover a part of the side surface 1d along the first direction D1 and are disposed on a part of the main surface 1a and on a part of the main surface 1b. The terminal electrode 12 is positioned close to the side surface 1e and the terminal electrode 14 is positioned close to the side surface 1f.

The terminal electrode 11 has an electrode portion 11a disposed on the main surface 1a, an electrode portion 11b disposed on the main surface 1b, and an electrode portion 11c disposed on the side surface 1c as illustrated in FIG. 2. The terminal electrode 11 is not disposed on the side surface 1d, the side surface 1e, and the side surface 1f. In other words, the terminal electrode 11 is disposed only on the three surfaces 1a, 1b, and 1c. The electrode portions 11a, 11b, and 11c adjacent to each other are connected on the ridge of the element body 1 and are electrically connected.

The electrode portion 11c entirely covers the end 24a of the connection conductor 24 exposed to the side surface 1c. The connection conductor 24 is connected to the electrode portion 11c at the end 24a exposed to the side surface 1c. In other words, the terminal electrode 11 and the connection conductor 24 are electrically connected.

The terminal electrode 12 has an electrode portion 12a disposed on the main surface 1a, an electrode portion 12b disposed on the main surface 1b, and an electrode portion 12c disposed on the side surface 1d as illustrated in FIG. 2. The terminal electrode 12 is not disposed on the side surface 1c, the side surface 1e, and the side surface 1f. In other words, the terminal electrode 11 is disposed only on the three surfaces 1a, 1b, and 1d. The electrode portions 12a, 12b, and 12c adjacent to each other are connected on the ridge of the element body 1 and are electrically connected.

The electrode portion 12c entirely covers the end 22a of the coil conductor 22 exposed to the side surface 1d. The coil conductor 22 is connected to the electrode portion 12c at the end 22a exposed to the side surface 1d. In other words, the terminal electrode 12 and the coil conductor 22 are electrically connected.

The terminal electrode 13 has an electrode portion 13a disposed on the main surface 1a, an electrode portion 13b disposed on the main surface 1b, and an electrode portion 13c disposed on the side surface 1c as illustrated in FIG. 3. The terminal electrode 13 is not disposed on the side surface 1d, the side surface 1e, and the side surface 1f. In other words, the terminal electrode 11 is disposed only on the three surfaces 1a, 1b, and 1c. The electrode portions 13a, 13b, and 13c adjacent to each other are connected on the ridge of the element body 1 and are electrically connected.

The electrode portion 13c entirely covers the end 21a of the connection conductor 21 exposed to the side surface 1c. The connection conductor 21 is connected to the electrode portion 13 c at the end 21a exposed to the side surface 1c. In other words, the terminal electrode 13 and the connection conductor 21 are electrically connected.

The terminal electrode 14 has an electrode portion 14a disposed on the main surface 1a, an electrode portion 14b disposed on the main surface 1b, and an electrode portion 14c disposed on the side surface 1d as illustrated in FIG. 3. The terminal electrode 14 is not disposed on the side surface 1c, the side surface 1e, and the side surface 1f. In other words, the terminal electrode 14 is disposed only on the three surfaces 1a, 1b, and 1d. The electrode portions 14a, 14b, and 14c adjacent to each other are connected on the ridge of the element body 1 and are electrically connected.

The electrode portion 14c entirely covers the end 23a of the coil conductor 23 exposed to the side surface 1d. The coil conductor 23 is connected to the electrode portion 14c at the end 23a exposed to the side surface 1d. In other words, the terminal electrode 14 and the coil conductor 23 are electrically connected.

The terminal electrodes 11 to 14 include a first electrode layer E1, a second electrode layer E2, a third electrode layer E3, and a fourth electrode layer E4. In the present embodiment, each of the electrode portions 11c, 12c, 13c, and 14c includes the first electrode layer E1, the second electrode layer E2, the third electrode layer E3, and the fourth electrode layer E4. Each of the electrode portions 11a, 11b, 12a, 12b, 13a, 13b, 14a, and 14b includes the second electrode layer E2, the third electrode layer E3, and the fourth electrode layer E4. In other words, each of the electrode portions 11a, 11b, 12a, 12b, 13a, 13b, 14a, and 14b does not include the first electrode layer E1. The fourth electrode layer E4 constitutes the respective outermost layers of the terminal electrodes 11 to 14.

The first electrode layer E1 is formed by conductive paste being applied to the surface of the element body 1 (side surfaces 1c and 1d in the present embodiment) and baked. The first electrode layer E1 is a sintered metal layer formed by sintering of the metal component (metal powder) contained in the conductive paste. In other words, the first electrode layer E1 is a sintered metal layer disposed on the element body 1.

The first electrode layer E1 is included in each of the electrode portions 11c, 12c, 13c, and 14c. The first electrode layer E1 included in each of the electrode portions 11c and 13c is disposed on the side surface 1c in such a way as to be in contact with the side surface 1c. The first electrode layer E1 included in each of the electrode portions 12c and 14c is disposed on the side surface 1d in such a way as to be in contact with the side surface 1d. In the present embodiment, the first electrode layer E1 is not disposed on the main surface 1a and the main surface 1b.

The first electrode layer E1 included in the electrode portion 11c is connected to the end 24a of the connection conductor 24. The first electrode layer E1 included in the electrode portion 12c is connected to the end 22a of the coil conductor 22. The first electrode layer E1 included in the electrode portion 13c is connected to the end 21a of the connection conductor 21. The first electrode layer E1 included in the electrode portion 14c is connected to the end 23a of the coil conductor 23.

In the present embodiment, the first electrode layer E1 is a sintered metal layer made of Ag. The first electrode layer E1 may be a sintered metal layer made of Pd. A mixture of Ag or Pd powder, a glass component, an organic binder, and an organic solvent is used as the conductive paste.

The second electrode layer E2 is a conductive resin layer. The second electrode layer E2 is integrally formed in each of the electrode portions 11a to 11c, 12a to 12c, 13a to 13c, and 14a to 14c. The edge of the second electrode layer E2 is included in each of the electrode portions 11a, 11b, 12a, 12b, 13a, 13b, 14a, and 14b. A mixture of a thermosetting resin and a conductive material, an organic solvent, and the like is used as the conductive resin. Metal powder or the like is used as the conductive material. Ag powder or the like is used as the metal powder. A phenol resin, an acrylic resin, a silicone resin, an epoxy resin, a polyimide resin, or the like is used as the thermosetting resin.

The third electrode layer E3 is a plating layer and is formed on the second electrode layer E2 by plating. The third electrode layer E3 is integrally formed in each of the electrode portions 11a to 11c, 12a to 12c, 13a to 13c, and 14a to 14c. The edge of the third electrode layer E3 is included in each of the electrode portions 11a, 11b, 12a, 12b, 13a, 13b, 14a, and 14b. In the present embodiment, the third electrode layer E3 is a Ni plating layer formed on the second electrode layer E2 by Ni plating. The third electrode layer E3 may be a Cu plating layer.

The fourth electrode layer E4 is a plating layer and is formed on the third electrode layer E3 by plating. The fourth electrode layer E4 is integrally formed in each of the electrode portions 11a to 11c, 12a to 12c, 13a to 13c, and 14a to 14c. The edge of the fourth electrode layer E4 is included in each of the electrode portions 11a, 11b, 12a, 12b, 13a, 13b, 14a, and 14b. In the present embodiment, the fourth electrode layer E4 is a Sn plating layer formed on the third electrode layer E3 by Sn plating.

The second electrode layer E2 is disposed on the first electrode layer E1 and is in contact with the first electrode layer El in the electrode portions 11c, 12c, 13c, and 14c. In other words, the second electrode layer E2 is not in direct contact with the element body 1 in the electrode portions 11c, 12c, 13c, and 14c. The third electrode layer E3 and the fourth electrode layer E4 constitute the plating layer disposed on the second electrode layer E2. In other words, in the present embodiment, the plating layer formed on the second electrode layer E2 has a two-layer structure. In each of the electrode portions 11 a to 11c, 12a to 12c, 13a to 13c, and 14a to 14c, the entire second electrode layer E2 is covered with the plating layer that the third electrode layer E3 and the fourth electrode layer E4 constitute.

The second electrode layer E2 included in each of the electrode portions 11c, 12c, 13c, and 14c is disposed on the element body 1 and is in contact with the first electrode layer E1. The connection conductor 21, the coil conductor 22, the coil conductor 23, and the connection conductor 24 are electrically connected to the second electrode layer E2 through the first electrode layer E1. Accordingly, in the multilayer common mode filter CF, the connection strength between each of the coil conductor 21, the coil conductor 22, the coil conductor 23, and the connection conductor 24 and the corresponding terminal electrodes 11 to 14 is higher than in a configuration in which the second electrode layer E2 and the connection conductor 21, the coil conductor 22, the coil conductor 23, and the connection conductor 24 are directly connected, and each of the coil conductor 21, the coil conductor 22, the coil conductor 23, and the connection conductor 24 and the corresponding terminal electrodes 11 to 14 are electrically connected with reliability.

As described above, in the multilayer common mode filter CF, the magnetic region 6, the non-magnetic region 7, the magnetic region 8, and the non-magnetic region 9 are laminated in this order on the non-magnetic portion 3 in each of the magnetic portions 5. The glass component of the non-magnetic portion 3 diffuses in the vicinity of the interface with the non-magnetic portion 3 in the magnetic region 6. The glass component of the non-magnetic region 7 diffuses in the vicinity of the interface with the non-magnetic region 7 in the magnetic region 6. The glass component of the non-magnetic region 7 diffuses in the vicinity of the interface with the non-magnetic region 7 in the magnetic region 8. The glass component of the non-magnetic region 9 diffuses in the vicinity of the interface with the non-magnetic region 9 in the magnetic region 8. As a result, firing of a magnetic layer becomes less likely near the interfaces in the magnetic regions 6 and 8, and thus thermal contraction is suppressed. The thermal contraction of the magnetic portion 5 is suppressed by the effect of the interfaces.

Although the thermal shrinkage of the magnetic regions 6 and 8 is smaller than the thermal shrinkage of the non-magnetic portion 3 and the non-magnetic regions 7 and 9, an increase in volume leads to an increase in absolute thermal contraction amount. Since the magnetic regions 6 and 8 are divided by the non-magnetic region 7, the volume per region is smaller than in the case of non-division. Accordingly, thermal contraction is suppressed. The non-magnetic region 7 functions as a buffer suppressing the thermal contraction of the magnetic regions 6 and 8 by dividing the magnetic regions 6 and 8.

The non-magnetic portion 3 and the non-magnetic region 7 are disposed on both sides of the magnetic region 6. As a result, the stresses on both sides of the magnetic region 6 are balanced. In a case where the stresses on both sides are not balanced, structural defects such as peeling and cracks are likely to occur at the interface between the non-magnetic portion 3 and the magnetic region 6 or the interface between the magnetic region 6 and the non-magnetic region 7. In the multilayer common mode filter CF, the structural defects attributable to the imbalance between the stresses on both sides are suppressed.

The non-magnetic regions 7 and 9 are disposed on both sides of the magnetic region 8. As a result, the stresses on both sides of the magnetic region 8 are balanced. In a case where the stresses on both sides are not balanced, structural defects such as peeling and cracks are likely to occur at the interface between the non-magnetic region 7 and the magnetic region 8 or the interface between the magnetic region 8 and the non-magnetic region 9. In the multilayer common mode filter CF, the structural defects such as the peeling and cracks attributable to the imbalance between the stresses on both sides are suppressed.

The sum of the length L3 and the length L7 is equal to or less than the length L6 (L3+L7≤L6). As a result, the volumes of the non-magnetic portion 3 and the non-magnetic region 7 are smaller than in a case where the sum of the length L3 and the length L7 exceeds the length L6 (L3+L7>L6), and thus an increase in the amount the glass components of the non-magnetic portion 3 and the non-magnetic region 7 diffuse to the magnetic region 6 is suppressed. Accordingly, deterioration of the magnetic properties of the magnetic region 6 is suppressed. The sum of the length L7 and the length L9 is equal to or less than the length L8. As a result, the volumes of the non-magnetic regions 7 and 9 are smaller than in a case where the sum of the length

L7 and the length L9 exceeds the length L8 (L7+L9>L8), and thus an increase in the amount the glass components of the non-magnetic regions 7 and 9 diffuse to the magnetic region 8 is suppressed. Accordingly, deterioration of the magnetic properties of the magnetic region 8 is suppressed.

The shorter the lengths L3, L7, and L9, the smaller the volumes of the non-magnetic portion 3 and the non-magnetic regions 7 and 9. The glass component diffusion amount is reduced as a result. When the lengths L3, L7, and L9 are excessively short, however, the non-magnetic portion 3 and the non-magnetic regions 7 and 9 are not formed with ease. In the multilayer common mode filter CF, the lengths L3, L7, and L9 are 0.1 μm or more, and thus the non-magnetic portion 3 and the non-magnetic regions 7 and 9 can be appropriately formed.

The length L9 is equal to or greater than the length L7. Accordingly, the volume of the non-magnetic region 9 is equal to or greater than the volume of the non-magnetic region 7, and thus the strength of the non-magnetic region 9 can be equal to or greater than the strength of the non-magnetic region 7. The non-magnetic region 9 is disposed closer to the outer side of the element body 1 than the non-magnetic region 7 and is susceptible to external stress. Accordingly, the structural defects can be further suppressed by the strength of the non-magnetic region 9 being equal to or greater than the strength of the non-magnetic region 7.

In the multilayer common mode filter CF, the terminal electrodes 11 to 14 have the second electrode layer E2, which is a conductive resin layer. The second electrode layer E2 is softer than the first electrode layer E1, which is a sintered metal layer. Accordingly, the external force that acts on the multilayer common mode filter CF from the electronic device can be suppressed when, for example, the multilayer common mode filter CF is solder-mounted onto the electronic device. Accordingly, cracking of the element body 1 is suppressed.

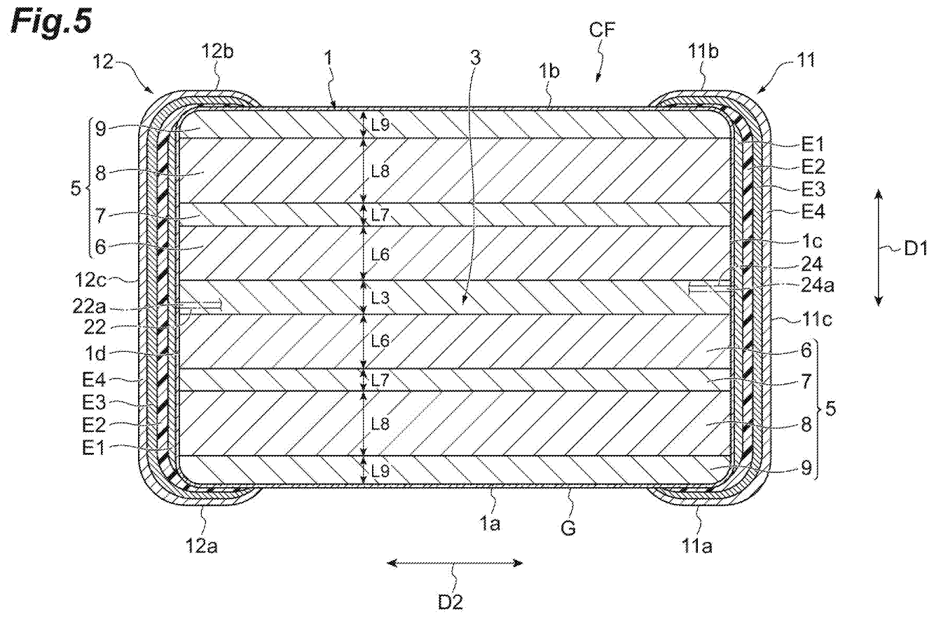

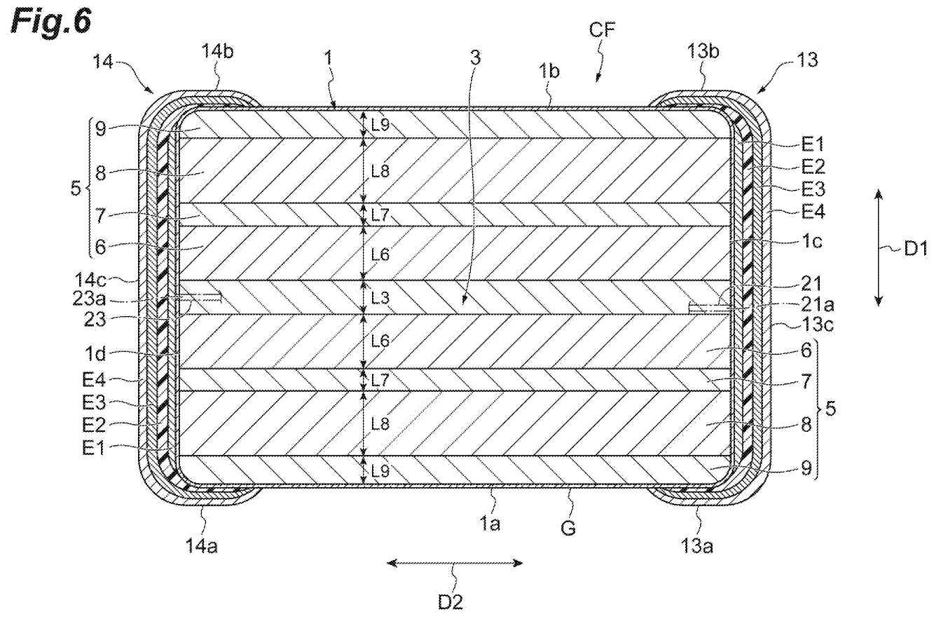

Next, the configuration of the multilayer common mode filter CF according to a modification example of the present embodiment will be described with reference to FIGS. 5 and 6. FIGS. 5 and 6 are cross-sectional views illustrating the multilayer common mode filter according to the modification example of the present embodiment.

The multilayer common mode filter CF illustrated in FIGS. 5 and 6 differs from the multilayer common mode filter CF illustrated in FIGS. 1 to 4 in that an amorphous glass coat layer G applied to the element body 1 is further provided. The amorphous glass coat layer G is in contact with the outer surface of the element body 1 and covers the entire outer surface. The amorphous glass coat layer G is disposed between the element body 1 and the terminal electrodes 11 to 14 and is in contact with the element body 1 and the terminal electrodes 11 to 14. The amorphous glass coat layer G is made of a glass material such as silica-based glass (SiO₂—B₂O₃—ZrO₂—R₂O-based glass).

The end 24a of the connection conductor 24 exposed to the side surface 1c penetrates the amorphous glass coat layer G and is connected to the electrode portion 11c. The end 22a of the coil conductor 22 exposed to the side surface 1d penetrates the amorphous glass coat layer G and is connected to the electrode portion 12c. The end 21a of the connection conductor 21 exposed to the side surface 1c penetrates the amorphous glass coat layer G and is connected to the electrode portion 13c. The end 23a of the coil conductor 23 exposed to the side surface 1d penetrates the amorphous glass coat layer G and is connected to the electrode portion 14c.

The adhesion between the element body 1 and the terminal electrodes 11 to 14 can be enhanced by means of the amorphous glass coat layer G. Accordingly, peeling of the terminal electrodes 11 to 14 is suppressed. The amorphous glass coat layer G may be provided only on, for example, main surfaces 2a and 2b. In this case, the amorphous glass coat layer G has parts that are disposed between the main surface 2a and the electrode portions 11a, 12a, 13a, and 14a and are in contact with the main surface 2a and the electrode portions 11a, 12a, 13a, and 14a and parts that are disposed between the main surface 2b and the electrode portions lib, 12b, 13b, and 14b and are in contact with the main surface 2b and the electrode portions lib, 12b, 13b, and 14b.

The present invention is not necessarily limited to the embodiment described above. Various modifications are possible within the gist of the present invention.

In the multilayer common mode filter CF, at least one of the magnetic portions 5 may have a configuration in which the magnetic region 6, the non-magnetic region 7, the magnetic region 8, and the non-magnetic region 9 are laminated in this order on the non-magnetic portion 3. For example, a magnetic region may constitute the other magnetic portion 5 alone. Even in this case, it is possible to suppress structural defects and deterioration of magnetic properties as well as thermal contraction in at least one of the magnetic portions 5.

The terminal electrodes 11 to 14 may not necessarily have the second electrode layer E2. The plating layer disposed on the second electrode layer E2 may not necessarily have a two-layer structure or a three-layer structure. The plating layer disposed on the second electrode layer E2 may be a single layer or may have a multilayer structure of four or more layers.

The terminal electrode 11 may be connected to the end 24a of the connection conductor 24 and may not have the electrode portions 11a and 11b. The terminal electrode 12 may be connected to the end 22a of the coil conductor 22 and may not have the electrode portions 12a and 12b. The terminal electrode 13 may be connected to the end 21a of the connection conductor 21 and may not have the electrode portions 13a and 13b. The terminal electrode 14 may be connected to the end 23a of the coil conductor 23 and may not have the electrode portions 14a and 14b.

Although the multilayer common mode filter CF is provided with the connection conductor 21, the coil conductor 22, the coil conductor 23, and the connection conductor 24 disposed in different layers, the internal conductor of the multilayer common mode filter CF is not limited to this configuration.

The number of the external electrodes (terminal electrodes) that are respectively disposed in the end portions of the element body 1 in the second direction D2 is not limited to “two”. The number of the external electrodes that are respectively disposed in the end portions of the element body 1 in the second direction D2 may be “three” or more.

What is claimed is:

1. A multilayer coil component comprising:
an element body having a non-magnetic portion and a pair of magnetic portions disposed in such a way as to sandwich the non-magnetic portion; and
a coil conductor disposed in the non-magnetic portion, wherein
at least one of the pair of magnetic portions includes a first magnetic region, a first non-magnetic region, a second magnetic region, and a second non-magnetic region that are laminated in this order on the non-magnetic portion,
each of the non-magnetic portion, the first non-magnetic region, and the second non-magnetic region contains a glass component,
a sum of a first length of the non-magnetic portion in a lamination direction and a second length of the first non-magnetic region in the lamination direction is equal to or less than a third length of the first magnetic region in the lamination direction,
a sum of the second length and a fourth length of the second non-magnetic region in the lamination direction is equal to or less than a fifth length of the second magnetic region in the lamination direction, and
the fourth length is equal to or greater than the second length.

2. The multilayer coil component according to claim 1, wherein each of the pair of magnetic portions includes the first magnetic region, the first non-magnetic region, the second magnetic region, and the second non-magnetic region that are laminated in this order on the non-magnetic portion.

3. The multilayer coil component according to claim 1, further comprising an external electrode disposed on the element body and connected to the coil conductor,
wherein the external electrode has a conductive resin layer.

4. The multilayer coil component according to claim 1, further comprising:
an external electrode disposed on the element body and connected to the coil conductor; and
an amorphous glass coat layer disposed between the element body and the external electrode and in contact with the element body and the external electrode.
